(19) United States
(12) Patent Application Publication
(10) Pub. No.: US 2003/0074432 A1
(43) Pub. Date: Apr. 17, 2003

(54) State data management method and system

(76) Inventor: John Joseph Mazzitelli, Sicklerville, NJ (US)

Correspondence Address: HEWLETT-PACKARD COMPANY, Intellectual Property Administration, P.O. Box 272400, Fort Collins, CO, 80527-2400, US

(21) Appl. No.: 09/964,036

(22) Filed: Sep. 26, 2001

(51) Int. Cl. G06F 15/173

(52) U.S. Cl. 709/223; 709/217

(57) ABSTRACT

The present invention comprises a method for managing state data. The method comprises identifying state data from a response structured using an Internet communications protocol to be delivered to a uniquely identifiable client enabled to communicate using the Internet communications protocol and associating the state data with the client. The method also comprises storing the state data in a data storage area remote from the client, and delivering the response to the client.

### TECHNICAL FIELD OF THE INVENTION

The present invention relates in general to telecommunications and, more particularly, to a state data management method and system.

### BACKGROUND OF THE INVENTION

The Internet provides a venue for communication from a wide variety of devices, including wireless devices. Users may shop online and search the Internet for information about movie showing times, word definitions. Most communications over the Internet typically include the use of a protocol such as the Hyper Text Transfer Protocol (HTTP). Usually, a remote client such as a browser (such as Netscape® 6.01 or Microsoft's Internet Explorer) performs these functions by submitting an HTML request to a server, such as a web server for a web page.

Behind the scenes, additional data is transferred back and forth to facilitate certain aspects of these communications. Cookies are user-specific state information that are stored in a user's computer by web servers so that the data may be available for later access by itself or other servers, and are typically used to provide user-side customization of information as the user surfs the Internet. As some examples, cookies may be used to personalize search engines, to monitor whether users have entered a contest more than the single entry permitted, and to store shopping lists constructed by the user while browsing an online storefront.

A cookie is a state object that is a description of the range of URLs for which that state is valid. Any future requests made by the client which fall in that range will include a transmittal of the current value of the state object from the client back to the server. In operation, a cookie is typically a tagged string of text containing a user's preferences and are embedded in HTTP information flowing back and forth between web servers and the user's computer. A web server formats and sends a cookie to the user's browser, which receives and stores the cookie on the user's computer. Web servers may then access relevant cookies whenever the user establishes a connection to the web servers, usually by submitting requests.

Unfortunately, such a method typically suffers from disadvantages. For example, in some cases, a user may not accept data such as cookies. Because the use of cookies is almost ubiquitous, this user may not be able to access or use a particular website if it will not accept cookies. As another example, such a method also requires that the client have the capability to store cookie information. Unfortunately, in some cases some clients may not have this capability.

### SUMMARY OF THE INVENTION

From the foregoing, it may be appreciated that a need has arisen for providing a way to communicate state data to facilitate certain aspects of online communications. In accordance with the present invention, a state data management method and system are provided that substantially eliminate or reduce disadvantages and problems of conventional systems.

One aspect of the invention is a method for managing state data. The method comprises identifying state data from a response structured using an Internet communications protocol to be delivered to a uniquely identifiable client enabled to communicate using the Internet communications protocol and associating the state data with the client. The method also comprises storing the state data in a data storage area remote from the client, and delivering the response to the client.

Another aspect of the invention is a system for managing state data within amessage structured using an Internet communications protocol. The system comprises a server coupled to a uniquely identifiable client enabled to communicate using the Internet communications protocol and a data storage area operatively associated with the server and remote from the client. The system also comprises an application resident on the server. The application is operable to identify state data from aresponse structured using the Internet communications protocol to be delivered to the client, cause the state data to be associated with the client, and cause the state data to be stored in the data storage area. The application is further operable to cause the response to be delivered to the client.

Another aspect of the invention is an application for managing state data within amessage structured using an Internet communications protocol. The application comprises a computer-readable medium and application software associatively operable with the computer-readable medium. The application software is operable to identify state data from aresponse structured using the Internet communications protocol to be delivered to a uniquely identifiable client enabled to communicate using the Internet communications protocol and to cause the state data to be associated with the client. The application software is also operable to cause the state data to be stored in a data storage area remote from the client, and to cause the response to be delivered to the client.

### BRIEF DESCRIPTION OF THE DRAWINGS

For a more complete understanding of the present invention and the advantages thereof, reference is now made to the following description taken in conjunction with the accompanying drawings, wherein like reference numerals represent like parts, and in which:

FIG. 1 is an example of a block diagram of a system that may be used for delivering an HTTP message according to an embodiment of the present invention; and

FIG. 2 illustrates an example of a method for delivering an HTTP message according to an embodiment of the present invention.

### DETAILED DESCRIPTION OF THE DRAWINGS

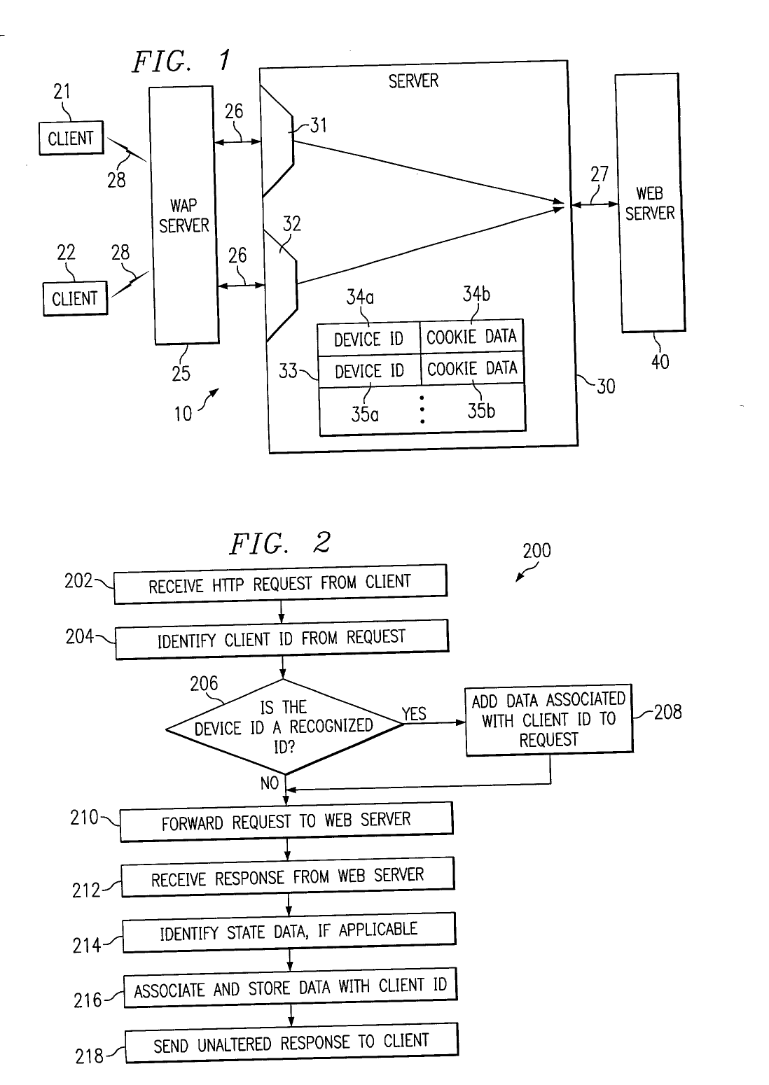

FIG. 1 is an embodiment of a block diagram of a state data delivery system 10. In the embodiment illustrated in FIG. 1, system 10 comprises a server 30 that may be used to execute applications managed by one or more message applications 31 and/or 32. One technical advantage of the invention is that the invention may provide a method for managing state data in amessage structured using an Internet communications protocol that provides for storage of the state data remotely from the client. Amessage structured using an Internet communications protocol may be a URL request sent by a client, or a response sent by a web server to the client in response to the request. As one example, messages that are structured using HTTP include specific HTTP-specific syntax that facilitates transfers of data by a server, such as a web server, from a requested URL to the requesting client. Such an advantage allows clients that are not able to receive state data such as cookies to navigate through various web sites, which typically require clients to accept the web server's placement of cookies in a memory location of the client. Moreover, such an advantage may allow persistent storage of cookies, as desired, that may not be possible with the use of traditional methods.

System 10 may be coupled to one or more remote clients 21 and/or 22 that are each enabled to communicate using an Internet communications protocol such as, but not limited to, HTTP and wireless application protocol (WAP), including clients that are WAP-enabled, such as wireless devices, from which it receives a URL request. Clients 21 and 22 may be coupled to server 30 by any type of communication link 26, whether wireless or otherwise. As illustrated in FIG. 1, server 30 may also optionally and alternatively be coupled to remote clients 21 and/or 22 via a WAP server 25. In such an embodiment, WAP server 25 is operable to receive WAP requests from clients 21 and/or 22 over a wireless communication link 25, convert them into requests structured using HTTP, or HTTP requests, and forward the requests to server 30. Similarly, WAP server 25 is operable to receive responses structured using HTTP, or HTTP responses, from server 30, convert them into responses structured using WAP, or WAP responses, and forward the WAP responses to clients 21 and/or 22.

Server 30 is operable to automatically forward the URL request to an intended web server or universal business server 40 that is coupled to server 30 by any type of communication link 27, whether wireless or otherwise. Server 30 may also in a particular embodiment control the overall function and operation of system 10. As illustrated in FIG. 1, server 30 may be a task-specific or custom-designed processing system that may be specifically configured to interface with various devices and to perform in accordance with the methods described herein. For example, in a particular embodiment, one or more applications 31 and/or 32 may reside in a Universal Session Manager product that may be implemented as a customized listener as part of a Universal Listener Framework (ULF) that is available from Hewlett-Packard Company. The ULF is an application framework, or set of related JAVA classes that may be used together for a particular application, and which may be used to handle requests from a variety of protocols. In the present invention, one or both of applications 31 and 32 may be used to perform state data management. Server 30 may also include any number of individual listeners (not explicitly shown) that may be used to process file transfer protocol (FTP), email, JAVA Message Server (JMS) and other protocols, and/or perform a variety of functions such as load balancing, using a number of various methods, as desired and according to the implementation.

Alternatively, one or more applications 31 and/or 32 may reside on a server 30 that may be another type of specific purpose or a general-purpose programmable computer, such as the ubiquitous personal computer (PC), which is well known in the art and readily commercially available. Server 30 may also include a portion of a computer adapted to execute any one of the well-known MS-DOS, PC DOS, OS2, UNIX, MAC OS, and WINDOWS operating systems, or other operating systems including unconventional operating systems. Server 30 may be coupled to remote clients 21 and/or 22 and/or web server 40 by any type of communication link.

Server 30 also includes a data storage area 33, which may be structured using a variety of methods, to store and recall device IDs 34a and 35a and state data 34b and 35b. Although the invention contemplates the management of other state data, the remainder of this description will utilize the term “cookie data” to describe state data transferred in online communications and managed according to the teachings of the present invention. Although FIG. 1 graphically illustrates a two-dimensional representation of a data storage area 33, the invention contemplates the use of a variety of methods and data storage known in the art or that may be developed in the future including, but not limited to, databases, flat files and other methods, to store and recall device IDs 34a and 35a and cookie data 34b and 35b.

Server 30 operates in conjunction with applications 31 and/or 32 to perform state data management. For example, in the embodiment shown in FIG. 1, server 30 may access and/or include programs or software routines of applications 31 and/or 32, depending on the particular application. Many methods for implementing a software architecture may be used and include, but are not limited to, the classes discussed below. Server 30 may be connected to, or include, a memory system, such as a cache or random access memory (not explicitly shown), suitable for storing all or a portion of these programs or routines and/or temporarily storing data during various processes performed by server 30. Memory may be used, among other things, to support real-time analysis and/or processing of data.

Remote clients 21 and/or 22 may be any network elements that are enabled to communicate using an Internet communications protocol, such as, for example, HTTP or WAP, and that may be uniquely identified via the protocol that each uses. That is, remote clients 21 and/or 22 may be browsers such as Internet Explorer that resides on any general or specific purpose computer, wireless device or other Internet appliance. Remote clients 21 and/or 22 are each operable to submit HTTP requests and receive responses using that protocol. For example, a WAP device identifies itself with a device ID in HTTP requests. This device ID is typically included in an HTTP header. The form of device ID typically varies but, as two examples, may be a name:value pair, such as John Doe: 303.555.1212, or in the form XSUPNUM. As one example, such a request may have the form http://server/Scripts/Function1.dol/ServerEngine.class/home.jsp. The device IDs may be parsed out in accordance with the invention. Other types of device IDs known now or developed in the future may also be used.

Although the invention contemplates numerous methods for implementing the method as is discussed below, an example may be illustrative before discussing the steps referred to in FIG. 2. In a particular embodiment, server 30 may utilize a software architecture that includes applications 31 and/or 32, and that may be logically composed of several classes and interfaces. These classes may operate in a distributed environment and communicate with each other using distributed communications methods, and may include a distributed component architecture such as Common Object Request Broker Architecture (CORBA), JAVA Remote Method Invocation (RMI), and ENTERPRISE JAVABEANS.

As another example, a method for providing state data management may in a particular embodiment utilize Universal Session Manager (USM) technology available from Hewlett-Packard Company. USM technology may, for example, utilize several classes in implementing an exemplary method as discussed below using the HTTP protocol. An HttpSessionProxy class may be used as a receiver or listener in the ULF on a particular port for HTTP requests incoming from clients 21 and 22. The HttpSessionProxy class filters out cookie data and associates them with device IDs 34a and 35a, and may then pass these requests through to web server 40 for further processing. In a particular embodiment, these requests may be processed through HttpSessionRequestExecutor, MemoryStorage, and HttpProtocolHandler classes. For example, the HttpSessionRequestExecutor class may be used to enable clients 21 and 22 such as WAP-enabled phones, which may not be operable to handle HTTP cookies at the gateway and/or device level, to maintain state by mapping cookie data to device IDs 34a and 35a. The HttpSessionRequestExecutor class communicates with an HttpProtocolHandler class, which may be used to send HTTP requests to web server 40 and to parse HTTP requests and/or responses. The HttpSessionRequestExecutor class also communicates with a MemoryStorageClass, which associates the cookie data 34b and 35b with device IDs 34a and 35a and stores them in data storage area 33. cookie data 34b and 35b may be stored in a variety of formats and may be, for example, encoded in BASE64. This class may also, depending on the application, include various parameters for purging data as desired.

Responses may similarly be passed from web server 40 to clients 21 and/or 22 through the HttpSessionRequestExecutor, MemoryStorage, and HttpProtocolHandler classes. A SocketBinaryOutputObject class may also be used to pass data to client 21 and/or 22. For example, this class may be used to decode data utilizing a configured decoding algorithm, and to output headers and data to a socket, which may then be passed via a context specified by the particular implementation.

FIG. 2 illustrates an example of a method for automatically forwarding an address according to an embodiment of the present invention. Various embodiments may utilize fewer or more steps, and the method may be performed using a number of different implementations, depending on the application. Generally, method 200 provides for a way to deliver data to a client 21 or 22 that provides for the storage of cookie data at a location remote from that client. The method provides the advantage of allowing all types of clients 21 and/or 22 to have their requests processed by and receive responses back from the web server. For example, the method works with those clients 21 and/or 22 that may not receive cookies; the cookie headers and cookie data that are structured using a particular protocol may be ignored by that client upon receipt. On the other hand, those clients 21 and/or 22 that may receive cookies will receive them. Such a method may save storage space on clients 21 and 22 that would otherwise be required with conventional methods.

In step 202, a request structured using an Internet protocol is received from a client 21 or 22. In step 204, the method identifies a client or device ID 34a or 35a from the request that uniquely identifies the client. As discussed above, device ID 34a or 35a is a unique device identifier, such as a name:value pair. Identification of device ID 34a or 35a includes copying the device ID while leaving the device ID intact in the request, and may be performed using a variety of methods, including parsing the device ID from the message. In step 206, the method queries whether device ID 34a or 35a is a recognized ID; that is, whether the method has processed information associated with device ID 34a or 35a during prior processing. Examples of such prior processing includes steps 212-216 in method 200. If so, the method continues in step 208, where any cookies associated with device ID 34a or 35a are added to the request to form a modified request. One method for adding these cookies is by embedding a cookie header that includes the cookie data in an appropriate place in the request. One example for a cookie header structured using HTTP is discussed below. The request is then forwarded to web server 40 in step 210.

The method then continues to step 212, where a response message is received from web server 40. The method identifies all cookie data, if any, from the response, similarly to the identification of the device ID as discussed above, and may include parsing the response. The cookie data remains intact in the response. In step 216, these cookie data are associated with device ID 34a or 35a and then stored in data storage area 33. These cookie data may be later retrieved from data storage area 33 for other requests as discussed in conjunction with steps 206 and 208. The method then in step 218 sends the response to the client 21 or 22 associated with the response.

As another example, the cookie data may be stored in a data storage area that is associated with device ID 34a or 35a. For example, it may in some embodiments be preferable to partition, allocate, or separately implement, storage areas according to client, business area, or a variety of a number of other factors, depending on the implementation. In addition, the cookie data may be stored in persistent storage such a file system or database. Persistent storage may improve the fault tolerance of system 10.

An example may be illustrative. Cookie HTTP request headers include cookie headers and set-cookie headers, and follow a specific syntax known to those in the art. For example, when requesting a URL from a web server, a browser will match the URL against all cookies and if any of them match, a line containing the name/value pairs of all matching cookies will be included in the HTTP request. One example of such a transaction includes client 21 (whose identifier as a customer is “Wile_E_Coyote” requests a document, (for example, information about a rocket launcher part). The request may have the form:

GET/Scripts/Acme.dll/MyApp.class/page.jsp HTTP/1.1

Date: Jul. 12, 2001 13:35:50 GMT

Device-id: 2278490

User-agent: WILE_E_COYOTE (Cartoon Corp)

The client would receive a response that may have the form:

HTTP/1.1 200 OK

Set-cookie: customerid=2012345, PART_NUMBER=ROCKET_LAUNCHER_{—}0001

Server: Microsoft IIS 4.0

Date: Jul. 12, 2001 13:35:00 GMT

<HTML>

Hello

</HTML>

This response identifies client Wile_E_Coyote as customerid 2012345, and includes cookie data sent by web server 40 that is in the form:

Set-cookie: customerid=2012345, PART_NUMBER=ROCKET_LAUNCHER_{—}0001

Were client 21 to request a URL in path “/” on web server 40 (usually by navigating a menu), that client sends to web server 40:

Cookie: customerid-=2012345

In this example, system 10 may utilize either the client name Wile_E_Coyote, customerid 2012345, or some other identifier as device ID 34a or 35a.

The present invention contemplates performing steps during the method in various order, and thus the present invention should not be regarded as limited to processes or inserted steps that are performed in any particular order in the method. For example, steps 216 and 218 may be reversed, or performed in parallel, depending on the application. Still other configurations are possible, depending on the types of data existing at any particular stage during the method, and on the particular implementation of system 10.

What is claimed is:

1. A method for managing state data, comprising:
identifying state data from a response structured using an Internet communications protocol to be delivered to a uniquely identifiable client enabled to communicate using the Internet communications protocol;
associating the state data with the client;
storing the state data in a data storage area remote from the client; and
delivering the response to the client.

2. The method of claim 1, further comprising:
receiving a request structured using the Internet communications protocol from the client;
identifying a client ID of the client;
modifying the request by adding the state data from the data storage area to the request; andsending the modified request to a web server.

3. The method of claim 2, further comprising:
determining whether the client ID is recognized; and
modifying the request by adding the state data from the data storage area to the request if the client ID is recognized.

4. The method of claim 1, wherein the client is a wireless device.

5. The method of claim 4, wherein the client utilizes one of the protocols from the group consisting of a wireless application protocol and a HyperText Transfer protocol.

6. The method of claim 1, wherein the data storage area comprises a database.

7. The method of claim 1, further comprising associating the state data with the client using a database.

8. A system for managing state data within amessage structured using an Internet communications protocol, comprising:
a server coupled to a uniquely identifiable client enabled to communicate using the Internet communications protocol;
a data storage area operatively associated with the server and remote from the client;
an application resident on the server and operable to
identify state data from aresponse structured using the Internet communications protocol to be delivered to the client;
cause the state data to be associated with the client;
cause the state data to be stored in the data storage area; and
cause the response to be delivered to the client.

9. The system of claim 8, wherein the application is further operable to:
receive a request structured using the Internet communications protocol from the client;
identify a client ID of the client;
modify the request by adding the state data from the data storage area to the request; andcause the modified request to be sent to a web server coupled to the server.

10. The system of claim 9, wherein the application is further operable to
determine whether the client ID is recognized; and
modify the request by adding the state data from the data storage area to the request if the client ID is recognized.

11. The system of claim 8, wherein the data storage area comprises a database.

12. The system of claim 8, wherein the application comprises one of a plurality of receivers in the server, the receivers each operable to receive and transfer messages using a unique protocol.

13. The system of claim 8, wherein the application comprises at least one class implemented in the JAVA language.

14. The system of claim 8, wherein the client is a wireless device.

15. The system of claim 14, wherein the client utilizes one of the protocols from the group consisting of a wireless application protocol and a HyperText Transfer protocol.

16. An application for managing state data within a message structured using an Internet communications protocol, comprising:
a computer-readable medium;
application software associatively operable with the computer-readable medium and operable to
identify state data from a response structured using the Internet communications protocol to be delivered to a uniquely identifiable client enabled to communicate using the Internet communications protocol;
cause the state data to be associated with the client;
cause the state data to be stored in a data storage area remote from the client; and
cause the response to be delivered to the client.

17. The application of claim 16, wherein the client is a wireless device.

18. The application of claim 17, wherein the client utilizes one of the protocols from the group consisting of a wireless application protocol and a HyperText Transfer protocol.

19. The application of claim 16, wherein the application software is further operable to
receive a request structured using the Internet communications protocol from the client;
identify a client ID of the client;
modify the request by adding the state data from the data storage area to the request; andcause the modified request to be sent to a web server coupled to the server.

20. The application of claim 19, wherein the application software is further operable to
determine whether the client ID is recognized; and
modify the request by adding the state data from the data storage area to the request if the client ID is recognized.

21. The application of claim 16, wherein the application software is further operable to associate the state data with the client using a database.

22. The application of claim 16, wherein the data storage area comprises a database.

23. The application of claim 16, wherein the application software comprises one of a plurality of receivers in the server, the receivers each operable to receive and transfer messages using a unique protocol.
